(19) United States
(12) Patent Application Publication
(10) Pub. No.: US 2013/0112407 A1
(43) Pub. Date: May 9, 2013

(54) Obtaining Data From An Earth Model Using Functional Descriptors

(71) Applicants: Yao-Chou Cheng, Houston, TX (US); Mark Dobin, The Woodlands, TX (US)

(72) Inventors: Yao-Chou Cheng, Houston, TX (US); Mark Dobin, The Woodlands, TX (US)

(21) Appl. No.: 13/810,445

(22) PCT Filed: May 23, 2011
(86) PCT No.: PCT/US11/37592

§ 371 Date: Jan. 15, 2013

Related U.S. Application Data
(60) Provisional application No. 61/371,012, filed on Aug. 5, 2010.

(51) Int. Cl. G06T 15/08; E21B 43/12

(52) U.S. Cl. CPC G06T 15/08; E21B 43/12
USPC 166/250.15; 345/419; 345/426

(57) ABSTRACT

There is provided a system and method for obtaining data corresponding to a physical property of interest from a three-dimensional (3D) earth model. An exemplary method comprises defining a region of interest in the 3D earth model via at least one functional descriptor. The exemplary method also comprises extracting data corresponding to the physical property of interest where the region of interest and the 3D earth model overlap.

### CROSS-REFERENCE TO RELATED APPLICATION

This application claims the benefit of U.S. Provisional Patent Application 61/371,012 filed Aug. 5, 2010 entitled OBTAINING DATA FROM AN EARTH MODEL

USING FUNCTIONAL DESCRIPTORS, the entirety of which is incorporated by reference herein.

### FIELD OF THE INVENTION

The present techniques relate to providing a representation of data corresponding to physical objects. In particular, an exemplary embodiment of the present techniques relates to using functional descriptors to define areas of interest for visualization of data stored in a physical property model, such as an earth model.

### BACKGROUND

This section is intended to introduce various aspects of the art, which may be associated with embodiments of the disclosed techniques. This discussion is believed to assist in providing a framework to facilitate a better understanding of particular aspects of the disclosed techniques. Accordingly, it should be understood that this section is to be read in this light, and not necessarily as admissions of prior art.

Three-dimensional (3D) model construction and visualization commonly employs data stored in a data volume organized as a structured grid or an unstructured grid. Data stored in a data volume may comprise a data model that corresponds to one or more physical properties about a corresponding region that may be of interest. Physical property model construction and data visualization have been widely accepted by numerous disciplines as a mechanism for analyzing, communicating, and comprehending complex 3D relationships. Examples of physical regions that can be subjected to 3D analysis include the earth's subsurface, facility designs and the human body.

Current practices of providing volume interpretations and visualizations of data regarding a 3D earth model for purposes of oil exploration generally relate to processing and visualizing geological data types such as seismic volumes, geo-modeling grids, fault surfaces, horizon grids, well data and/or the like. In connection with geological data, it may be desirable to visually represent engineering and geoscience data types, which may be point or non-spatial data. Examples of such data types include drilling information, daily/monthly production data, geochemical or geomechanical analysis results, production measurements or the like.

A technique for providing a 3D visualization of a portion of a data volume is known as sub-volume probing (alternatively, just probing). A probe is typically a simple geometric shape that is used to select one or more subsets of data from the data volume. The placement of the probe within the data volume may be selected by the user. Data corresponding to locations where the probe interfaces with the data volume may be displayed on the surface of the probe. Visualizations of data selected by the probe may be created to assist the user in understanding the data. The probe may be resized, re-shaped, and/or moved interactively by the user within the whole 3D volume data set. As the probe changes shape, size, or location in response to user input, the image is re-drawn at a rate so as to be perceived as real-time by the user. In this manner, the user is able to visualize and interpret the features and physical parameters that are inherent in the 3D volume data set.

Opacity control and color mapping functions may be used to highlight and display areas of interest of the data volume. Vertical and/or horizontal seismic data slices/slabs can be displayed as textured surfaces in inline/cross-line/time directions on a given seismic data. Multiple sub-volumes shown as a rectilinear sub-volume are also created to probe the data volume interactively.

Data may also be extracted from a data volume and visualized using a ribbon technique, which may comprise interfacing a line with a data volume. In particular, a ribbon section may be created as a surface by projecting a polyline into the data volume. Data may be extracted from cells that are intersected or overlapped by the ribbon section.

Current practices for the visualization and identification of the region of interest are based on mapping textural information for specific geometries that are either controlled by surfaces and/or simple rectangular shapes. For more complex region controls, such as highly irregular area of a geo-body, a corresponding control volume, also known as region volume, is created. The value of each cell of a region volume indicates whether its corresponding cell on the original data volume belongs (or does not belong) to a particular geological area. Typically, a sample in a 3D data volume can be represented by, for example, 1-bit, 8-bit, 16-bit, 32-bit or 64-bit data storage. However, creating a 1-bit region volume or using a bit per cell on the original data volume is generally applicable for region control. That is, a 1 (or 0) value on a cell of the volume indicates that the corresponding sample belongs (or does not belong) to a particular geological region. Those kinds of region controls are especially useful in applications based on pattern recognition and/or segmentation of data volume for object identification since the detected objects does not need to be regular and/or in a particular geometry shapes.

In addition, known region representation methods rely on data objects such as triangulated-surfaces. Alternatively, sub-volumes may be defined using limited topologies such as rectangular boxes. Moreover, known techniques employ a region volume that is created prior to rendering. FIG. 1 is an example of a visualization that can be created using known techniques.

FIG. 1 is a diagram of a visualization of a subsurface region. The diagram is generally referred to by the reference number 100. The diagram 100 is created based on data for a 3D earth model. A slab 102 of seismic data has been selected by a user to be displayed using a known method. In addition, probe regions 104, 106 show seismic data selected using known probe definition techniques. A plurality of well paths 108a, 108b, 108c, 108d are depicted as travelling through the subsurface region. A horizon 110 is shown, as is a target reservoir 112. Various other physical objects of interest are also depicted.

The following paragraphs of this Background section provide specific examples of known data extraction and visualization techniques. U.S. Pat. No. 7,248,258 to Acosta, et al., relates to a system and method for analyzing and imaging 3D volume data sets. A ribbon section is produced which may include a plurality of planes projected from a polyline. The polyline may include one or more line segments preferably formed within a plane. The projected planes intersect the 3D volume data set and the data located at the intersection may be selectively viewed. The polyline may be edited or varied by editing or varying the control points which define the polyline. In addition, a method is disclosed for quickly tracking a physical phenomena represented within the 3D volume data set. A plurality of planes may be successively displayed in the 3D volume data set from which points are digitized related to the structure of interest to create a spline curve on each plane. The area between the spline curves is interpolated to produce a surface representative of the structure of interest, which may for example be a fault plane described by the 3D volume data set. In this manner, the user can more easily and effectively visualize and interpret the features and physical parameters that are inherent in the 3D volume data set.

U.S. Pat. No. 7,133,041 to Kaufman, et al., discloses an apparatus and method for real-time volume processing and universal 3D rendering. The apparatus includes a plurality of 3D memory units; at least one pixel bus for providing global horizontal communication; a plurality of rendering pipelines; at least one geometry bus; and a control unit. The apparatus includes a block processor having a circular ray integration pipeline for processing voxel data and ray data. Rays are generally processed in image order thus permitting great flexibility (e.g., perspective projection, global illumination). The block processor includes a splatting unit and a scattering unit. A disclosed method for casting shadows and performing global illumination in relation to light sources includes sweeping a two-dimensional (2D) array of rays through the volume can also be implemented with the apparatus. A disclosed method for approximating a perspective projection includes using parallel projection.

U.S. Pat. No. 7,158,131 to Yamazaki, et al., relates to an implicit function field of a non-manifold that is held in a form of volume data. A value of an implicit function at a point between lattice points is decided by interpolation. If a difference in code distances between two adjacent voxels to be interpolated is larger than a fixed width, no surface is formed between the voxels. Furthermore, an entered curved surface is broken down into curved surface patches which enable determination of a front and a back. Numbers are given to the front and the back, respectively, to be distinguished from each other. A space is classified into a plurality of regions by using the number of a surface of a nearest point.

U.S. Patent Application Publication 20090103793 by Borland, et al., relates to methods, systems, and computer program products for processing 3D image data to render an image from a viewpoint within or beyond an occluding region of the image data are disclosed. In one disclosed method, a set of 3D image data is accessed. The image data includes image data for a surface of interest and image data for a region occluding the surface of interest from a desired viewpoint. The viewpoint may be within or beyond the occluding region. A plurality of rays is cast from the viewpoint to the surface. Along each ray, an occlusion determination is made independent from a volume rendering transfer function definition to render voxels within the occluding region as transparent or partially transparent. The volume rendering transfer function is applied along a portion of each ray outside of the occluding region to render voxels defining surface of interest as visible. The voxels that define the surface are displayed as visible. The voxels within the occluding region are shown in a transparent or partially transparent manner.

U.S. Patent Application Publication No. 20080030497 by Hu, et al., relates to a method for segmentation of 3D image data sets, to obtain digital models of objects identifiable in the image data set. The image data set may be obtained from any convenient source, including medical imaging modalities, geological imaging, industrial imaging, and the like. A graph cuts method is applied to the image data set, and a level set method is then applied to the data using the output from the graph cuts method. The graph cuts process comprises determining location information for the digital data on a 3D graph, and cutting the 3D graph to determine approximate membership information for the object. The boundaries of the object are then refined using the level set method. Finally, a representation of the object volumes can be derived from an output of the level set method. Such representation may be used to generate rapid prototyped physical models of the objects.

U.S. Pat. No. 6,980,935 to Lu, et al., relates to a method, computer system or computer program for interactively constructing, editing, rendering and manipulating geoscience models, including aggregating the functionality of a geometry system and a graphics system, enforcing consistency between the geometry system and the graphics system, and interfacing the geometry system and the graphics system to an application through an integration layer. State machines are also disclosed that enable updating of only those graphics objects whose geometry or topology have been changed and that are specified as visible by the user, thus increasing performance. A scenegraph construction technique is also provided to reduce memory requirements and further enhance performance. A material property framework is provided, among other things, to communicate changes in the geometry or topology to aggregate objects which then determine which graphics objects are affected by the changes and which graphics objects are to be updated.

U.S. Pat. No. 6,993,434 to Cheng, et al., relates to a method for processing data sets. One disclosed embodiment comprises defining at least two primary region constraints in the data sets by creating a corresponding constraint data set. At least two primary region constraints are combined using gated-logic expressions to create derived regions. Mapping functions are created from the gated-logic expressions of the derived regions. Desired derived regions are displayed through manipulation of the mapping functions. The method is described as permitting processing of multiple constraints in large data sets (such as, 3D seismic or discontinuity data).

U.S. Pat. No. 6,373,489 to Lu, et al., relates to a method, computer system and article of manufacture for visualizing a model including a first surface. The disclosed method includes determining, as the model is being built, the rendering resolution of a portion of the first surface based on a view frustum from which the first surface is to be viewed and rendering the portion of the first surface on the output device using the rendering resolution. The vertices and edges to be rendered are selected based on the view frustum, using view frustum culling and bounding sphere projection. The vertices and edges selected to be rendered are tessellated using incremental and decremental tessellation. The tessellated vertices and edges are rendered. Predictive techniques are used to estimate future view frustums. Quality may be traded off against performance by adjusting parameters. Material properties are represented. The disclosed method, computer system and article of manufacture allow adaptively visualizing geological data in a geoscience model by modifying the visualization of a geometry object according to a view frustum from which the geometry object is to be viewed.

Knoll, et al., “Interactive Ray Tracing of Arbitrary Implicits with SIMD Interval Arithmetic”, IEEE Symposium on Interactive Ray Tracing, September 2007, pp. 11-18, discloses an algorithm for interactively ray tracing arbitrary implicit surfaces. Interval arithmetic (IA) is used both for robust root computation and guaranteed detection of topological features. In conjunction with ray tracing, this allows for rendering a programmable implicit function from its definition. The disclosed method applies SIMD optimization of both the interval arithmetic computation and coherent ray traversal algorithm, delivering interactive results for complex implicit functions.

D. Luebke, “CUDA: Scalable Parallel Programming for High-Performance Scientific Computing”, Biomedical Imaging: From Nano to Macro, 5th IEEE International Symposium, June 2008, pp. 836-838, discloses that graphics processing units (GPUs) originally designed for computer video cards have emerged as powerful chips in a high-performance workstation. Unlike multicore CPU architectures, which currently ship with two or four cores, GPU architectures are “manycore” with hundreds of cores capable of running thousands of threads in parallel. NVIDIA's CUDA is stated to be a co-evolved hardware-software architecture that enables high-performance computing developers to harness the tremendous computational power and memory bandwidth of the GPU in the C programming language. CUDA programming model is described, and its use in the biomedical imaging community is suggested.

T. Frantes, et al., “Impact of Volume Interpretation & Visualization Technologies on Upstream Business”, Offshore Technology Conference, 2001, relates to visualization and analysis of seismic volumes, geological and reservoir modeling grids in a 3D earth model in an interactive setting. The paper relates that volume interpretation and visualization techniques can improve business results from regional exploration to mature field development, from seismic interpretation to detailed well planning, and from macroscopic to microscopic scales. Volume interpretation includes the methods and tools for efficient interpretation and analysis of 3D data using techniques such as geologic feature extraction, volumetric multi-attribute integration and analysis, and interactive well path planning. Visualization technologies facilitate the rapid comprehension of 3D data through the interactive rendering of volumes, surfaces, lines, and points.

P. Hall, “Implicit Volume Rendering of Generalised Cylinders”, Victoria University of Wellington, Department of Computer Science, Technical Report CS-TR-94/10, May 1994, relates to rendering the interior volume of generalized cylinders that are filled with a semi-translucent material. A point sampling method is proposed. Volumes that are defined by combining generalized cylinders via set theoretic operations may be rendered also. The original motivation for this work was to simulate an x-ray process that is capable of imaging networks of blood vessels. However, the rendering technique is not restricted to that domain and could be used in more general computer graphic applications. The principal characteristic of this rendering technique is that absorption is the only optical effect that is modeled.

### SUMMARY

An exemplary embodiment of the present techniques relates to a method for obtaining data corresponding to a physical property of interest from a 3D earth model. An exemplary method comprises defining a region of interest in the 3D earth model via at least one functional descriptor. The exemplary method also comprises extracting data corresponding to the physical property of interest where the region of interest and the 3D earth model overlap.

An exemplary method of obtaining data comprises providing a visualization of the extracted data corresponding to the physical property of interest. A pixel value may be defined by a blending operation.

In one exemplary embodiment, the visualization is produced using a volume rendering technique. The volume rendering technique may comprise a ray casting operation. Also, the volume rendering technique may comprise parallel functional evaluation operations.

According to the present techniques, a functional descriptor may be formulated by an implicit function or an explicit function. A visualization of the 3D earth model may be provided in real time. The visualization may highlight the region of interest. Data corresponding to the physical property of interest may be processed via a graphical processing unit.

A functional descriptor according to the present techniques may be combined with another functional descriptor via at least one Boolean operation. The at least one Boolean operation may be represented by a tree structure.

In one exemplary embodiment, the region of interest may be redefined by modifying the at least one functional descriptor.

The 3D earth model may comprise geological and geophysical data. Additionally, The 3D earth model may comprise a structured grid or an unstructured grid. The functional descriptor may define the region of interest with respect to a co-ordinate system that describes the 3D earth model. The region of interest may be further defined in terms of a sub-volume probe, a slab or a slice of the 3D earth volume.

A computer system according to an exemplary embodiment of the present techniques is adapted to obtain data corresponding to a physical property of interest from a 3D earth model. An exemplary computer system comprises a processor and a non-transitory, computer-readable storage medium that stores computer-readable instructions for execution by the processor. The computer-readable instructions may comprise code that causes the processor to define a region of interest in the 3D earth model via at least one functional descriptor. The computer-readable instructions may also comprise code that causes the processor to extract data corresponding to the physical property of interest where the region of interest and the 3D earth model overlap. An exemplary embodiment may comprise computer-readable instructions that cause the processor to provide a visualization of the extracted data corresponding to the physical property of interest.

An exemplary embodiment of the present techniques relates to a method for producing hydrocarbons from an oil and/or gas field using data corresponding to a physical property of interest of the oil and/or gas field. The oil and/or gas field may be represented by a 3D earth model. An exemplary method of extracting hydrocarbons comprises defining a region of interest in the 3D earth model via at least one functional descriptor. The exemplary method may also comprise extracting data corresponding to the physical property of interest where the region of interest and the 3D earth model overlap. Hydrocarbons may be extracted from the oil and/or gas field using the data extracted from the 3D earth model.

### BRIEF DESCRIPTION OF THE DRAWINGS

Advantages of the present techniques may become apparent upon reviewing the following detailed description and drawings of non-limiting examples of embodiments in which:

FIG. 1 is a diagram of a visualization of a subsurface region;

FIG. 2 is a process flow diagram showing a method for obtaining data corresponding to a property of interest from a data volume according to exemplary embodiments of the present techniques;

FIG. 3 is a diagram showing a back-to-front volume rendering process;

FIG. 4 is a diagram showing a rendering process in which an image is produced from a perspective perpendicular to a viewing direction;

FIG. 5 is a diagram that is useful in explaining a rendering method that uses parallel rays that are cast through a 3D data volume;

FIG. 6 is a diagram that shows pixels generated using data extracted from a data volume;

FIG. 7 is a diagram showing a visualization of a first region of interest defined using functional descriptors in accordance with an exemplary embodiment of the present techniques;

FIG. 8 is a diagram showing a visualization of a second region of interest defined using implicit expressions in accordance with an exemplary embodiment of the present techniques;

FIG. 9 is a process flow diagram showing a method for producing hydrocarbons from an oil and/or gas field according to exemplary embodiments of the present techniques; and

FIG. 10 is a block diagram of a computer system that may be used to perform a method for obtaining data describing a physical structure from a data volume according to exemplary embodiments of the present techniques.

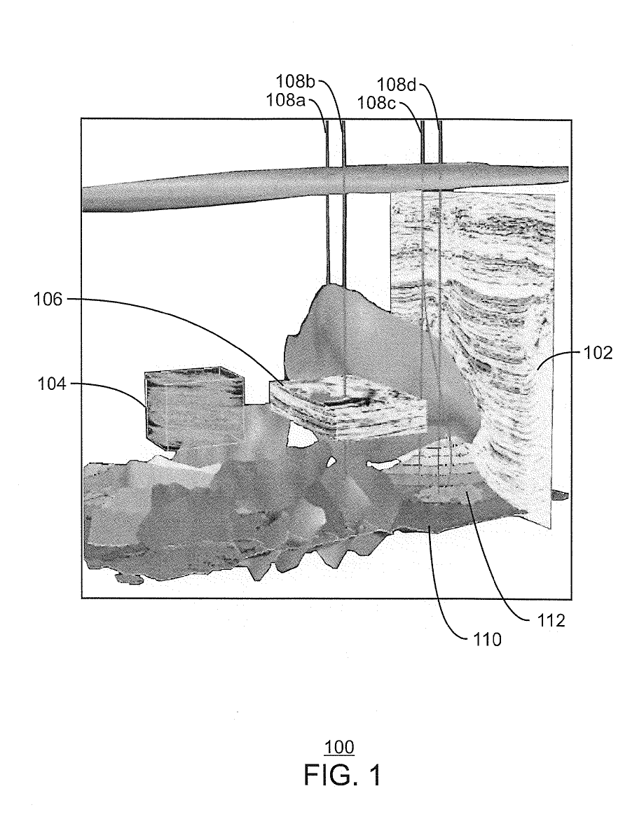

### DETAILED DESCRIPTION

In the following detailed description section, specific embodiments are described in connection with preferred embodiments. However, to the extent that the following description is specific to a particular embodiment or a particular use, this is intended to be for exemplary purposes only and simply provides a description of the exemplary embodiments. Accordingly, the present techniques are not limited to embodiments described herein, but rather, it includes all alternatives, modifications, and equivalents falling within the spirit and scope of the appended claims.

At the outset, and for ease of reference, certain terms used in this application and their meanings as used in this context are set forth. To the extent a term used herein is not defined below, it should be given the broadest definition persons in the pertinent art have given that term as reflected in at least one printed publication or issued patent.

As used herein, the term “computer component” refers to a computer-related entity, either hardware, firmware, software, a combination thereof, or software in execution. For example, a computer component can be, but is not limited to being, a process running on a processor, a processor, an object, an executable, a thread of execution, a program, and a computer. One or more computer components can reside within a process and/or thread of execution and a computer component can be localized on one computer and/or distributed between two or more computers.

As used herein, the terms “computer-readable medium”, “non-transitory, computer-readable medium” or the like refer to any tangible storage that participates in providing instructions to a processor for execution. Such a medium may take many forms, including but not limited to, non-volatile media, and volatile media. Non-volatile media includes, for example, NVRAM, or magnetic or optical disks. Volatile media includes dynamic memory, such as main memory. Computer-readable media may include, for example, a floppy disk, a flexible disk, hard disk, magnetic tape, or any other magnetic medium, magneto-optical medium, a CD-ROM, any other optical medium, a RAM, a PROM, and EPROM, a FLASH-EPROM, a solid state medium like a holographic memory, a memory card, or any other memory chip or cartridge, or any other physical medium from which a computer can read. When the computer-readable media is configured as a database, it is to be understood that the database may be any type of database, such as relational, hierarchical, object-oriented, and/or the like. Accordingly, exemplary embodiments of the present techniques may be considered to include a non-transitory, computer-readable storage medium or tangible distribution medium and prior art-recognized equivalents and successor media, in which the software implementations embodying the present techniques are stored.

As used herein, the term “earth model” refers to a geometrical/volumetric model of a portion of the earth that may also contain material properties. The model is shared in the sense that it integrates the work of several specialists involved in the model's development (non-limiting examples may include such disciplines as geologists, geophysicists, petrophysicists, well log analysts, drilling engineers and reservoir engineers) who interact with the model through one or more application programs.

As used herein, the term “explicit function” refers to a function in which a dependent variable is defined in terms of an independent variable. An example of an explicit function is y=f(x).

As used herein, the term “functional descriptor” refers to as implicit and/or explicit formulations of equation and inequality (or combinations of both) of one or more independent variables. For example x²/a²+y²/b²+z²/c²<=1 is a functional descriptor representing a standard axis-aligned ellipsoid body (including the interior) in an xyz-Cartesian coordinate system with radii a, b and c along the x,y,z axis respectively.

As used herein, the term “implicit function” refers to a function in which a dependent variable is not defined directly (explicitly) in terms of an independent variable. An example of an implicit function is f(x, y)>100.

As used herein, the term “polyline” refers to an ordering of points. A polyline may be displayed as connected line segments (or cylinders) and may or may not be closed. Properties of polylines may be used to provide color or varying the thickness of the polyline and may be discrete or interpolated between known points.

As used herein, the term “primitive” refers to a basic geometric shape. Examples of 2D primitives include rectangles, circles, ellipses, polygons, points, lines or the like. Examples of 3D primitives include cubes, spheres, ellipsoids, cones, cylinders or the like.

As used herein, the term “property” refers to data representative of a characteristic associated with different topological elements on a per element basis. Generally, a property could be any computing value type, including integer and floating point number types or the like. Moreover, a property may comprise vectors of value types. Properties may only be valid for a subset of a geometry object's elements. Properties may be used to color an object's geometry. The term “property” may also refer to a characteristic or stored information related to an object. Application of the appropriate definition is intuitive to one skilled in the art of computer science.

As used herein, the term “seismic data” refers to a multi-dimensional matrix or grid containing information about points in the subsurface, where the information was obtained using seismic methods. Seismic data typically is represented using a structured grid. Seismic attributes or properties are cell- or voxel-based. Seismic data may be volume rendered with opacity, color or texture mapped on a surface.

As used herein, the term “structured grid” refers to a matrix of volume data points known as voxels. Structured grids are typically used with seismic data volumes or medical imaging.

As used herein, the term “topological elements” refers to the building blocks of an object. Points, faces, or cells are the most common examples.

As used herein, the term “unstructured grid” refers to a collection of cells with arbitrary geometries. Each cell can have the shape of a prism, hexahedron, or other more complex 3D geometries. When compared to structured grids, unstructured grids can better represent actual data since unstructured grids can contain finer (i.e. smaller) cells in one area with sudden changes in value of a property, and coarser (i.e. larger) cells elsewhere where the value of the property changes more slowly. Finer cells may also be used in areas having more accurate measurements or data certainty (for example, in the vicinity of a well). The flexibility to define cell geometry allows the unstructured grid to represent physical properties better than structured grids. In addition, unstructured grid cells can also better resemble the actual geometries of subsurface layers because cell shape is not restricted to a cube and may be given any orientation. However, all cell geometries need to be stored explicitly, thus an unstructured grid may require a substantial amount of memory. Unstructured grids may be employed in connection with reservoir simulation models. Note that the term unstructured grid relates to how data is defined and does imply that the data itself has no structure. For example, one could represent a seismic model as an unstructured grid with explicitly defined nodes and cells. The result would necessarily be more memory intensive and inefficient to process and visualize than the corresponding structured definition.

As used herein, the terms “visualization engine” or “VE” refer to a computer component that is adapted to present a model and/or visualization of data that represents one or more physical objects.

As used herein, the term “cell” refers to a collection of faces, or a collection of nodes that implicitly define faces, where the faces together form a closed volume.

As used herein, the term “face” refers to an arbitrary collection of points that form a surface.

As used herein, the term “voxel” refers to the smallest data point in a 3D volumetric object. Each voxel has unique set of coordinates and contains one or more data values that represent the properties at that location. Each voxel represents a discrete sampling of a 3D space, similar to the manner in which pixels represent sampling of the 2D space. The location of a voxel can be calculated by knowing the grid origin, unit vectors and the indices of the voxel. As voxels are assumed to have similar geometries (such as cube-shaped), the details of the voxel geometries do not need to be stored, thus structured grids require relatively little memory. However, dense sampling may be needed to capture small features, therefore increasing computer memory usage requirements.

As used herein, the term “well” refers to a surface location with a collection of wellbores.

As used herein, the term “wellbore” refers to a constituent underground path of a well and associated collections of path dependent data. A wellbore may be visually rendered as a collection of connected line segments or curves. Wellbores may also be visually rendered cylindrically with a radius. They can also be rendered as volumetric shapes by wellbore properties/attributes.

Some portions of the detailed description which follows are presented in terms of procedures, steps, logic blocks, processing and other symbolic representations of operations on data bits within a computer memory. These descriptions and representations are the means used by those skilled in the data processing arts to most effectively convey the substance of their work to others skilled in the art. In the present application, a procedure, step, logic block, process, or the like, is conceived to be a self-consistent sequence of steps or instructions leading to a desired result. The steps are those requiring physical manipulations of physical quantities. Usually, although not necessarily, these quantities take the form of electrical or magnetic signals capable of being stored, transferred, combined, compared, and otherwise manipulated in a computer system.

It should be borne in mind, however, that all of these and similar terms are to be associated with the appropriate physical quantities and are merely convenient labels applied to these quantities. Unless specifically stated otherwise as apparent from the following discussions, it is appreciated that throughout the present application, discussions using the terms such as “adjusting”, “comparing”, “computing”, “creating”, “defining”, “determining”, “displaying”, “extracting”, “limiting”, “obtaining”, “processing”, “performing”, “predicting”, “producing”, “providing”, “selecting”, “storing”, “transforming”, “updating” or the like, refer to the action and processes of a computer system, or similar electronic computing device, that transforms data represented as physical (electronic) quantities within the computer system's registers and memories into other data similarly represented as physical quantities within the computer system memories or registers or other such information storage, transmission or display devices. Example methods may be better appreciated with reference to flow diagrams.

While for purposes of simplicity of explanation, the illustrated methodologies are shown and described as a series of blocks, it is to be appreciated that the methodologies are not limited by the order of the blocks, as some blocks can occur in different orders and/or concurrently with other blocks from that shown and described. Moreover, less than all the illustrated blocks may be required to implement an example methodology. Blocks may be combined or separated into multiple components. Furthermore, additional and/or alternative methodologies can employ additional, not illustrated blocks. While the figures illustrate various serially occurring actions, it is to be appreciated that various actions could occur concurrently, substantially in parallel, and/or at substantially different points in time.

In an exemplary embodiment, data describing a 3D region or physical structure may be stored in a 3D data array (a data volume) having cells that correspond to specific locations of the 3D region. Each of the cells may be referred to herein as a voxel. Stored data may represent one or more physical properties about the 3D region.

By way of example, a typical post-stacked seismic data volume is represented by a 3D rectangular data structure, denoted by X, Y, Z dimensions. The dimensions correspond to the in-line, cross-line and wave traveling time or depth respectively. A regular data volume of 100 cells by 100 cells by 100 cells would include a total of 1,000,000 cells. Each cell in the volume may be assigned one or more data values representing the corresponding drilling or subsurface properties at this particular subsurface location. Cell-based subsurface data volumes could also have face properties (cell-to-cell), or vector properties to examine attributes such as fluid transmissibility, flow directionality, flow flux, flow rates or any other static or dynamic subsurface property that would benefit the geological/geophysical analysis.

Exemplary embodiments of the present techniques may provide the ability to interrogate, explore and provide visualizations of 3D data volumes. The results may be useful to both geoscientist and engineers in the oil and gas industry. Moreover, this interrogation may be particularly desirable in relation to the proximity of planned or drilled wells. Data relating to physical properties of interest retrieved as a result of an interrogation may be displayed as one or more properties of the path.

As a specific example, embodiments of the present techniques may be employed to provide methods of interrogation/extracting model property data for a given well path for purposes of well planning within a 3D earth model. Exemplary embodiments of the present techniques may employ advanced computing platforms and increase the flexibility and usability of interactive volume interpretation and processing in the 3D shared earth model. Moreover, exemplary embodiments relate to methods and processes for controlling, visualizing and processing regions of interest having simple shapes, complex shapes or combinations thereof.

As explained herein, an exemplary method may employ functional object descriptions to isolate dynamic areas, called Implicit Regions, within a 3D visualization environment for the purpose of 3D data volume rendering and processing. An Implicit Region is a constrained area within a data volume that is defined via the evaluations of a set of implicit functions, explicit function, parametric equations and/or functional defined primitives, collectively referred to herein as “functional descriptors.” The desired regions in 3D data volumes can thus be revealed by manipulating these functional descriptors through a series of set-theoretic Boolean formulations. Exemplary embodiments may provide effective evaluation of regions of interest in 3D data volumes in a similar manner to a 3D data model in a computer-aided design system.

Representations of primitive objects can be accurately formulated using implicit, explicit and/or any other parametric functional descriptors. By transforming the functional descriptors of the objects, the desired regions of interest can be identified and rendered interactively. By applying parallel ray casting and/or other GPU processing and/or geometry, vertex, fragment programming, the expensive functional evaluations during the volume rendering stages for the given functional descriptions can be accomplished much more efficiently.

An exemplary embodiment of the present techniques provides a method for visualization, analysis, and processing of regions of interest in a data volume by utilizing rapid evaluation of functional expressions. Such an exemplary method could also be used in an interactive environment in which a user can formulate the equations/expressions and/or combinations of them via Boolean operations to create/identify regions of interests interactively. In an exemplary embodiment, a visualization of a 3D earth model is provided in real time. The visualization may highlight the region of interest using opacity, color or the like.

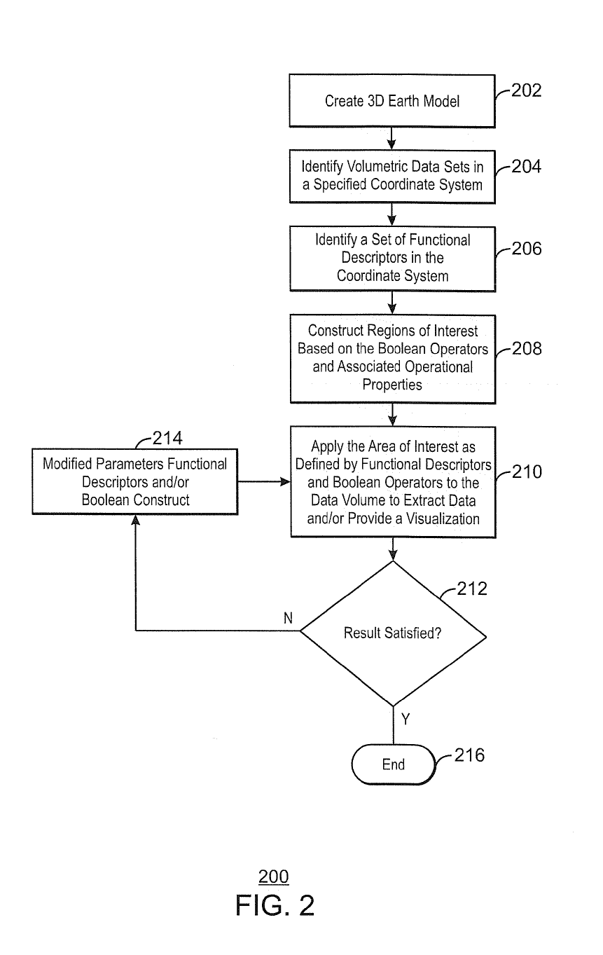

FIG. 2 is a process flow diagram showing a method for obtaining data corresponding to a property of interest from a data volume according to exemplary embodiments of the present techniques. The diagram is generally referred to by the reference number 200. The exemplary embodiment shown in FIG. 2 relates to obtaining data that may be useful in hydrocarbon exploration.

An exemplary embodiment relates to the use of functional descriptors to define regions of interest in a data volume that describes a 3D space. Data corresponding to physical properties of the 3D space may be extracted from the data volume in places where the functional descriptor intersects with the data volume. A visualization of the data may be produced and used for purposes of analysis. Boolean operators may be used to combine multiple functional descriptors to define the region of interest.

At block 202, a 3D earth model is created. The 3D earth model may contain a wide range of geological and geophysical data. Some examples of data objects include pre-stack or post-stack seismic data volumes, geological model data grids and/or reservoir model grids. Moreover, the 3D earth model contains data that describes physical properties of a portion of the subsurface region of the earth, including a 3D representation of an oil and/or gas field with one or more potential reservoirs.

As shown at block 204, the earth model is stored in one or more volumetric data sets (data volumes) using a specified coordinate system. The coordinate system may be used to describe or identify cells in a structured or unstructured grid that makes up the data volumes that store the 3D earth model.

A set of functional equations—implicit or explicit functions, and/or parametric descriptors is identified, as shown at block 206. As explained herein, an implicit function is a function whose relations to the variables are expressed in a form of equation for which the function has not been solved explicitly. For example, in equations containing x and y, separating the variables and express variable y via a function of x may be a relatively complex task. If an equation for y is not solved, y may be referred to as an implicit function of x. Implicit functions can often be useful in situations where it is impractical from a standpoint of computational resources to solve explicitly from the given equation. Even if it is feasible to solve and formulate the equation to express y as an explicit function f(x) of x, it may not be desirable to do so since the expression of f(x,y,z) may be much more complicated and/or less useful than the expression of the equation.

According to an exemplary embodiment, Implicit Regions may be defined to correspond to regions of interest in a data volume. By way of example, a region of interest may correspond to an area surrounding particular subsurface feature, such as a well bore or a fault. An Implicit Region can be used to define areas within data volumes constrained by a set of implicit functions and/or functional defined objects.

A cell in a 3D data volume may represent a geological location, and may be denoted as (x,y,z). Moreover, an implicit function for variables x, y, and z can be expressed as an equation R(x,y,z)=0 in which the equation indicates the constraint relationships for variable x, y and z. In other words, locations (x,y,z) satisfying the given constraint R(x,y,z)=0 in 3D space would represent an area of interest, a 3D implicit surface object.

In one example, given a volume data set, a given implicit function could potentially divide the volume data set into three disjoint areas of interest, namely areas in the constraint equation R(x,y,z)>0, R(x,y,z)=0, and R(x,y,z)<0 respectively. An Implicit Region for a given 3D data set may be defined and expressed as combinations of these disjoint regions.

Using the example of a regular data volume as an input, an Implicit Region that uses the expression R(x,y,z)<0 can be obtained by functional evaluation of the R(x, y, z) for each cell in (x,y,z) location. All the cells with the evaluated value less than 0 would be considered in the desired area of interest. Since each evaluation of the cell is independent of other cells, this evaluation process could also be done in parallel. This parallelism is suitable for massive multi-core and/or light-weighted processing units such as a GPU. In an exemplary embodiment, a visualization of an entire 3D earth model is provided and updated in real time. Moreover, such an exemplary embodiment does not merely reproduce the region of interest at successive times. The visualization of the earth model may be produced in such a way that the region of interest is highlighted using opacity, color or the like.

In one exemplary embodiment, an Implicit Region can be constructed in a tree structure, denoted as Implicit Region Control (IRC). The tree structure may comprise set-theoretic operation (such as Union, Intersection, Negate, Difference, . . . ), allowing extremely complex constraint regions of interest to be created.

In an exemplary embodiment, a tree structure used to define an Implicit Region may comprise a tree structure of the type used in constructive solid geometry (CSG), in which solid models are constructed as Boolean combinations of primitives. In one exemplary embodiment, a GPU implementation of arbitrary solid models can be constructed using complex CSG expression in real-time.

In one exemplary embodiment, functional descriptors such as implicit functions may be used as a primary way to represent primitive shapes in order to constrain regions of interests. Other representations, such as explicit functions and/or parameterized geometrical description, could also be used to define regions via their respective functional evaluation methods on the given 3D data volumes.

At block 208, regions of interest may be constructed from functional descriptors such as implicit functions using Boolean operators, in conjunction with associated operational properties of the region of interest. Moreover, Boolean operators may be used in conjunction with functional descriptors to define regions of interest in a data volume.

At block 210, the area of interest defined by functional descriptors such as implicit functions and Boolean operators is applied to a data volume to extract data corresponding to a property of interest. In addition, a visualization of the extracted data may be produced, for example, via volume rendering.

In performing analysis on a region of interest, a user may evaluate a result produced by an exemplary embodiment of the present techniques. In particular, a user may view a visualization produced by an exemplary embodiment and evaluate whether a particular set of implicit functions has accurately captured the region of interest. This determination is represented in FIG. 2 by a decision block 212. If, at block 212, the user determines that the particular set of implicit functions, including the effect of Boolean operators, if any, does not correctly identify the desired region of interest, the implicit functions and/or Boolean operators may be modified, as shown at block 214. Thereafter, process flow returns to block 210. If, at block 212, the user determines that the implicit function(s) has produced an acceptable region of interest, process flow may come to an end.

Examples of changes that may be made to implicit functions that define a region of interest at block 214 include repositioning or reshaping the region of interest via modifying the subject implicit function. For example, the origin of an implicit function may be changed. The result of this operation would move the same shape of region around different locations of the data volume. The parameters of the implicit function may also be modified for the purpose of shape deformation such as enlarge or shrink the area of interest. The implicit regions can also be re-composed in region tree control to further extend, alter to explore other region of interest.

As set forth herein, data extracted from a data volume according to the present techniques may be visualized to assist in analysis. An exemplary embodiment of the present techniques relates to the “volume rendering” of a data volume on a graphical display workstation. In general, a volume rendering practice refers to a process that paints/draws higher dimensional data objects in a specific viewing angle onto 2D images, display buffers and/or computer screens. Volume rendering may be performed in different ways, any of which may be used to provide visualizations of data according to the present techniques. One known technique employs “back-to-front” (or front-to-back) rendering in which a sequence of 2D-slice (or slab) textures of the original data volume are obtained and blended at a certain viewing angle to produce the final image to be displayed.

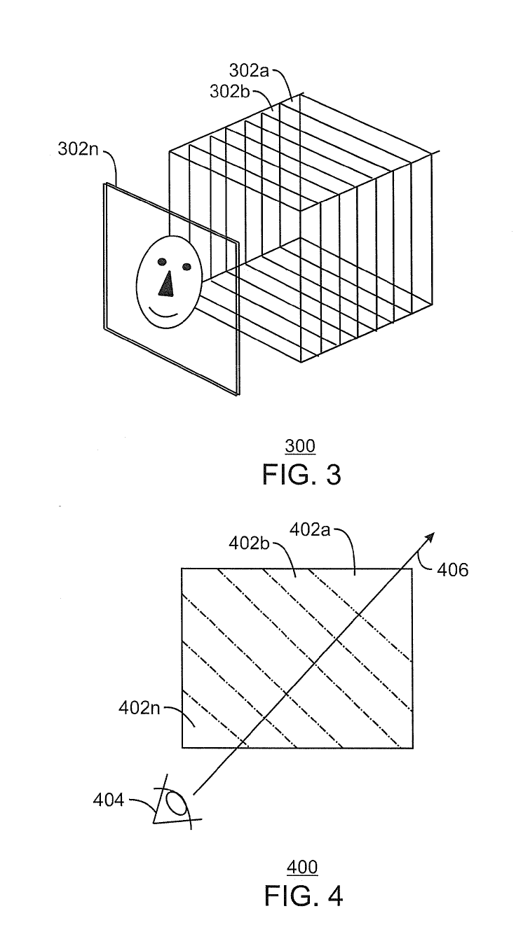

FIG. 3 is a diagram showing a back-to-front volume rendering process. The diagram is generally referred to by the reference number 300. A sequence of slices 302a, 302b, 302n obtained starting with the far distance to the viewer are used as texture images and sent to graphic display buffer. In one exemplary embodiment, textural information in the form of 2D image data may be mapped onto geometrical objects in two or higher dimensional space. These kinds of region representations may be used in interactive inspection or to browse areas of interest during interactive interpretations.

The final result of this “back-to-front” volume rendering method may be shown as one display image. The back-to-front volume rendering process may be used to provide a visualization of a region of interest according to exemplary embodiments of the present techniques.

FIG. 4 is a diagram showing a rendering process in which an image is produced from a perspective perpendicular to a viewing direction. The diagram is generally referred to by the reference number 400. The diagram 400 comprises a plurality of segments or slices 402a, 402b, 402n that are each constructed from a perspective perpendicular to a viewing angle of a viewer 404. Moreover, the slices 402a, 402b, 402n of a data volume may be taken from a different viewing angle that is not necessarily parallel to a rectangular axis 406 of the data volume. Exemplary embodiments of the present techniques may apply such a rendering process using computational platforms such as graphics processing units (GPUs) and/or other parallel computing units, for parallel functional evaluation to allow real-time applications and interactions.

Another rendering method employs approximate perspective volumetric ray casting of a 3D volume data based on a selected viewing and processing parameters. This method and other ray casting rendering methods would cast a set of rays through the data volume in one viewing direction. The viewing angle could be a perspective and/or a parallel. Each ray would intersect the cells of the data volume along the ray path. The data values on the path of the ray are then blended and displayed as a pixel value in a 2D display image.

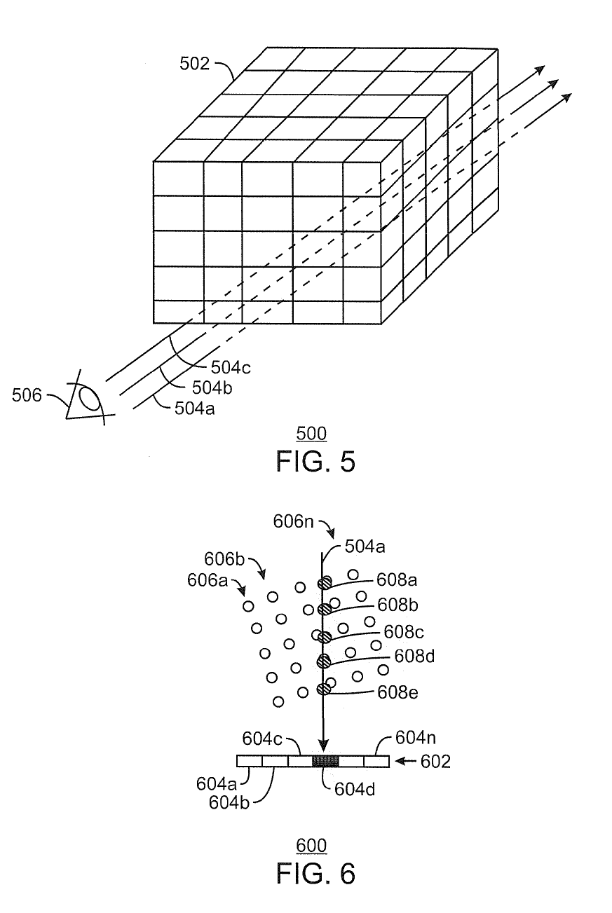

FIG. 5 is a diagram that is useful in explaining a rendering method that uses parallel rays that are cast through a 3D data volume. The diagram is generally referred to by the reference number 500. The diagram 500 shows a data volume 502 that comprises a plurality of cells. Parallel rays 504a, 504b, 504c are cast through the data volume 502 from the perspective of a viewer 506. Moreover, parallel ray casting as a rendering method would cast a set of rays through the data volume in a specified viewing direction. The number of rays depends on the resolution of the final display image.

For each pixel in the display image, a ray would intersect the cells of the data volume along the ray path. Instead of blending the values for all the cell values along the path, each cell could be evaluated through the implicit region equations and their implicit region control structure. In an exemplary embodiment, only the cell value evaluated to satisfy the given constraints would be used for the blending operation. Typically, the blending operation would sum all the contributions from the selected cell values, such as colors and opacity values, based on some sort of mathematical weighted algorithms to derive the final color and opacity. To speed up the evaluation and blending process, the summing operation may also be terminated earlier once the full opacity for along the ray path has been achieved.

According to one exemplary embodiment, additional blending operations may be performed for each ray path. For example, the cells that satisfied the evaluation constraint could be weighted more on certain colors. The coloring and/or weighted contribution could also base on other criteria such as gradient values and/or differences around the cells. The whole data volume can thus be rendered and processed with different height-lighted effects on different areas of interests.

Another exemplary embodiment may use a GPU processing program known as a “shader” to perform the evaluation of one or more implicit regions and their associated region tree control to render and process the regions of interest. A “shader” is a set of software instructions and/or programming methods primarily used to calculate rendering effects on graphics hardware with a relatively large degree of flexibility. Moreover, shaders may be used to program a GPU programmable rendering pipeline. GPU may be used in place of a fixed-function pipeline that allows only common geometry transformation and pixel shading functions. As shown with respect to FIG. 3, a sequence of slices may be obtained during the volume rendering stage. Each slice may be blended from “back-to-front” (or front-to-back) as the traditional volume rendering pipeline. The equations and implicit region control structure could then be used to constrain the pixels in the rendering buffer via the functional evaluations using the shader on the GPU. The blending process would then determine the final color and opacity in parallel for the final display image. A process of providing a visualization using data from cells of the data volume 502 is further explained with reference to FIG. 6.

FIG. 6 is a diagram that shows pixels generated using data extracted from the data volume 502. The diagram is generally referred to by the reference number 600. The diagram 600 shows a display panel 602, which comprises a plurality of pixels 604a, 604b, 604c, 604d, 604n. A ray 504a corresponds to one of the parallel rays 504a, 504b, 504c projected through the data volume 502. The diagram 600 includes rows 606a, 606b, 606n of data elements extracted from cells of the data volume 502. Each of the circular elements in the rows 606a, 606b, 606n comprises an element of data that describes a physical property of a region corresponding to the data volume 502. Values of data elements that fall along a path of the ray 504a may be blended to create a set of blended data elements 608a, 608b, 608c, 608d, 608e. In turn, values for the blended data elements 608a, 608b, 608c, 608d, 608e may be combined to form a value for the pixel 604d, which is shown as a shaded rectangle in FIG. 6. In a similar manner, values may be created for the other pixels that make up the display panel 602. GPUs or other parallel processing units may be used to perform these operations in a computationally efficient manner.

From the above description, a regular grid of data volumes is used to explain how 3D data can be processed and rendered based on various ways of the obtaining and blending the data value. According to the present techniques, volume rendering and processing for other data representations, such as stratigraphic grids (semi-regular data grids used in geological models) and/or irregular grids (used mainly in reservoir modeling) would also be applicable.

An exemplary embodiment can also provide “volume rendering” of areas of interest in a single volume data set and/or “co-rendering” of areas of interests in multi-dimensional data sets. Thus, users may be able to rapidly discover, interpret, and process geological/geophysical/engineering objects from multi-dimensional volume data sets.

### EXAMPLES

The examples set forth below refer to the following implicit functions:

R₁(x, y, z)=x²/a²+y²/a²+z²/a²−r Eqn. 1

R₂(x,y,z)=x²/b²−y²/c²−z+d Eqn. 2

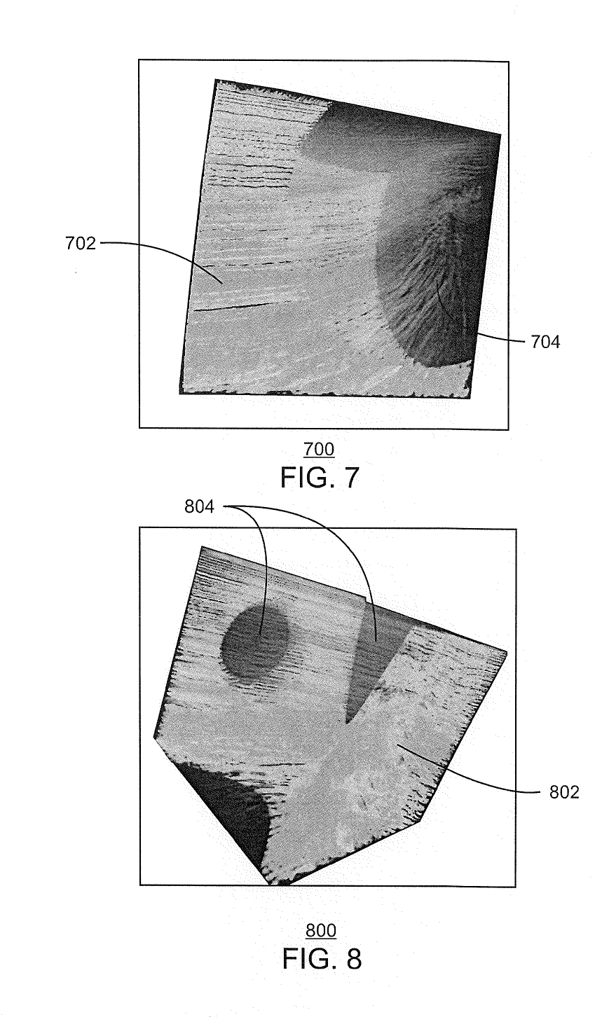

FIG. 7 is a diagram showing a visualization of a first region of interest defined using implicit expressions in accordance with an exemplary embodiment of the present techniques. The diagram is generally referred to by the reference number 700. In the diagram 700, the first region of interest A (referred to by the reference number 702) corresponds to an implicit region defined by the implicit relationship R₁(x,y,z)<0 within a seismic data volume. The first region of interest A (702) is displayed in a semi-transparent mode in the diagram 700. Portions of the data volume not defined by the implicit relationship R₁(x,y,z)<0 are displayed in an opaque mode, as indicated by the reference number 704.

FIG. 8 is a diagram showing a visualization of a second region of interest defined using implicit expressions in accordance with an exemplary embodiment of the present techniques. The diagram is generally referred to by the reference number 800. The diagram 800 shows two regions defined by implicit relationships. In particular, an implicit region B is represented by the implicit expression R₁(x,y,z)<0 with a=10 and an implicit region C is represented by the implicit expression R₂(x,y,z)<0. A region of interest 802 is represented by an implicit region defined as C-B. The region of interest 802 is displayed in semi-transparent mode in the diagram 800. Portions of the data volume not defined by the implicit relationship C-B (i.e., portions not within the region of interest 802) are displayed in an opaque mode, as indicated by the reference number 804.

According to the present techniques, color mapping and display parameters may be the same for each implicit region. An exemplary embodiment may also allow a user to redefine parameters for each display region separately. Furthermore, a centroid of each implicit region can be controlled by the user interactively. The result of those operations allows the user to highlight the regions of interest. In addition, the moving regions of interests can also allow the user to probe the entire data volume in real time.

Exemplary embodiments may be employed to render and process sub-volume probes, slices and slabs according to the present techniques. Moreover, an area of interest may be defined using implicit regions, as set forth herein. Thereafter, filters may be defined for a seismic volume such as a convolution operator, a discontinuity operator and/or a diffusion operator. Volume rendering may be performed (for example, using a ray casting technique). In so doing, the operators may be applied to each intersected region. The result of the operation may thus be used in a final accumulation value. A centroid of each defined implicit region may be moved. Sub-volume probes, slices and/or slabs may also be defined by a user and combined with the implicit regions. In this manner, statistics may be obtained and analysis performed.

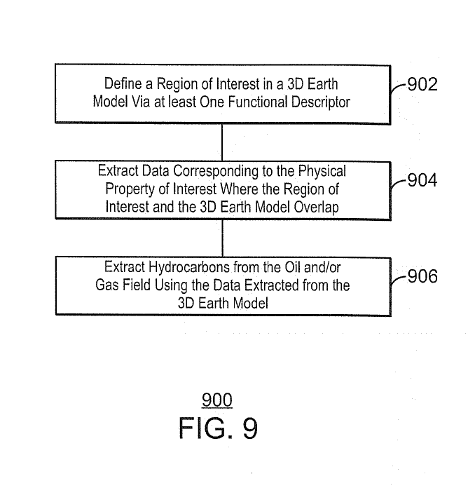

FIG. 9 is a process flow diagram showing a method for producing hydrocarbons from an oil and/or gas field according to exemplary embodiments of the present techniques.

The process is generally referred to by the reference number 900. The process 900 employs exemplary embodiments set forth herein for obtaining data corresponding to a property of interest from a 3D earth model using functional descriptors. Those of ordinary skill in the art will appreciate that a visualization engine according to the present techniques may facilitate the production of hydrocarbons by producing time-based models and/or visualizations that allow geologists, engineers and the like to determine a course of action to take to enhance hydrocarbon production from a subsurface region. By way of example, a 3D or 4D visualization produced according to an exemplary embodiment of the present techniques may allow an engineer or geologist to determine well properties in case of a fracture near a wellbore. The visualization and underlying physical property model data may be used to increase production of hydrocarbons from a subsurface region.

At block 902, the process begins with the defining of a region of interest in the 3D earth model via at least one functional descriptor. Data corresponding to the physical property of interest is extracted from the 3D earth model where the region of interest and the 3D earth model overlap, as shown at block 904. As shown at block 906, hydrocarbons are extracted from the oil and/or gas field using the data extracted from the 3D earth model.

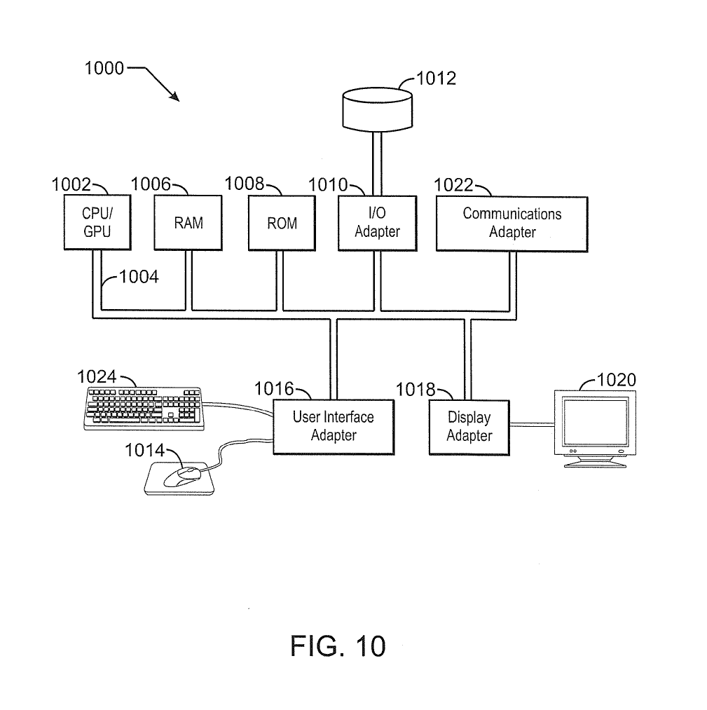

FIG. 10 is a block diagram of a computer system that may be used to perform a method for obtaining data corresponding to a property of interest from a data volume according to exemplary embodiments of the present techniques. A central processing unit (CPU) 1002 is coupled to system bus 1004. The CPU 1002 may be any general-purpose CPU, although other types of architectures of CPU 1002 (or other components of exemplary system 1000) may be used as long as CPU/GPU 1002 (and other components of system 1000) supports the inventive operations as described herein. Those of ordinary skill in the art will appreciate that, while only a single CPU 1002 is shown in FIG. 10, additional CPUs may be present. Moreover, the computer system 1000 may comprise a networked, multi-processor computer system that may include a hybrid parallel CPU/GPU system. The CPU 1002 may execute the various logical instructions according to various exemplary embodiments. For example, the CPU 1002 may execute machine-level instructions for performing processing according to the operational flow described above in conjunction with FIG. 2 or FIG. 9.

The computer system 1000 may also include computer components such as computer-readable media. Examples of computer-readable media include a random access memory (RAM) 1006, which may be SRAM, DRAM, SDRAM, or the like. The computer system 1000 may also include additional computer-readable media such as a read-only memory (ROM) 1008, which may be PROM, EPROM, EEPROM, or the like. RAM 1006 and ROM 1008 hold user and system data and programs, as is known in the art. The computer system 1000 may also include an input/output (I/O) adapter 1010, a communications adapter 1022, a user interface adapter 1016, and a display adapter 1018. In an exemplary embodiment of the present techniques, the display adapted 1018 may be adapted to provide a 3D representation of a 3D earth model. Moreover, an exemplary embodiment of the display adapter 1018 may comprise a visualization engine or VE that is adapted to provide a visualization of extracted data. The I/O adapter 1010, the user interface adapter 1016, and/or communications adapter 1022 may, in certain embodiments, enable a user to interact with computer system 1000 in order to input information.

The I/O adapter 1010 preferably connects a storage device(s) 1012, such as one or more of hard drive, compact disc (CD) drive, floppy disk drive, tape drive, etc. to computer system 1000. The storage device(s) may be used when RAM 1006 is insufficient for the memory requirements associated with storing data for operations of embodiments of the present techniques. The data storage of the computer system 1000 may be used for storing information and/or other data used or generated as disclosed herein. User interface adapter 1016 couples user input devices, such as a keyboard 1024, a pointing device 1014 and/or output devices to the computer system 1000. The display adapter 1018 is driven by the CPU 1002 to control the display on a display device 1020 to, for example, display information or a representation pertaining to a portion of a subsurface region under analysis, such as displaying a visualization of data extracted by defining a region of interest in terms of an implicit function, according to certain exemplary embodiments.

The architecture of system 1000 may be varied as desired. For example, any suitable processor-based device may be used, including without limitation personal computers, laptop computers, computer workstations, and multi-processor servers. Moreover, embodiments may be implemented on application specific integrated circuits (ASICs) or very large scale integrated (VLSI) circuits. In fact, persons of ordinary skill in the art may use any number of suitable structures capable of executing logical operations according to the embodiments.

In an exemplary embodiment of the present techniques, input data to the computer system 1000 may comprise geologic and geophysical data volumes/models such as seismic volumes, geological models and reservoir models. Input data may additionally comprise engineering data, such as drilled well paths and/or planned well paths. Computational implementations according to exemplary embodiments of the present techniques may comprise connections and/or access to computational implementations of processes to model and investigate the engineering and reservoir model properties and path creation method. Relevant connections may include facilities to perform geological model analysis, reservoir simulation, engineering analysis or the like.

The present techniques may be susceptible to various modifications and alternative forms, and the exemplary embodiments discussed above have been shown only by way of example. However, the present techniques are not intended to be limited to the particular embodiments disclosed herein. Indeed, the present techniques include all alternatives, modifications, and equivalents falling within the spirit and scope of the appended claims.

What is claimed is:

1. A method for obtaining data corresponding to a physical property of interest from a three-dimensional (3D) earth model, the method comprising:
defining a region of interest in the 3D earth model via at least one functional descriptor; and
extracting data corresponding to the physical property of interest where the region of interest and the 3D earth model overlap.

2. The method recited in claim 1, comprising providing a visualization of the extracted data corresponding to the physical property of interest.

3. The method recited in claim 2, comprising defining a pixel value by a blending operation.

4. The method recited in claim 2, wherein the visualization is produced using a volume rendering technique.

5. The method recited in claim 4, wherein the volume rendering technique comprises a ray casting operation.

6. The method recited in claim 4, wherein the volume rendering technique comprises parallel functional evaluation operations.

7. The method recited in claim 1, wherein the functional descriptor is formulated by an implicit function or an explicit function.

8. The method recited in claim 1, comprising providing a visualization of the 3D earth model in real time, the visualization highlighting the region of interest.

9. The method recited in claim 1, comprising processing data corresponding to the physical property of interest via a graphical processing unit.

10. The method recited in claim 1, comprising combining the at least one functional descriptor with another functional descriptor via at least one Boolean operation.

11. The method recited in claim 10, wherein the at least one Boolean operation is represented by a tree structure.

12. The method recited in claim 1, comprising redefining the region of interest by modifying the at least one functional descriptor.

13. The method recited in claim 1, wherein the 3D earth model comprises geological and geophysical data.

14. The method recited in claim 1, wherein the 3D earth model comprises a structured grid or an unstructured grid.

15. The method recited in claim 1, wherein the functional descriptor defines the region of interest with respect to a co-ordinate system that describes the 3D earth model.

16. The method recited in claim 1, comprising further defining the region of interest in terms of a sub-volume probe, a slab or a slice of the 3D earth volume.

17. A computer system that is adapted to obtain data corresponding to a physical property of interest from a three-dimensional (3D) earth model, the computer system comprising:
a processor; and
a non-transitory, computer-readable storage medium that stores computer-readable instructions for execution by the processor, the computer-readable instructions comprising:
code that, when executed by the processor, is adapted to cause the processor to define a region of interest in the 3D earth model via at least one functional descriptor; and
code that, when executed by the processor, is adapted to cause the processor to extract data corresponding to the physical property of interest where the region of interest and the 3D earth model overlap.

18. The computer system recited in claim 17, wherein the computer-readable instructions comprise code that, when executed by the processor, is adapted to cause the processor to provide a visualization of the extracted data corresponding to the physical property of interest.

19. A method for producing hydrocarbons from an oil and/or gas field using data corresponding to a physical property of interest of the oil and/or gas field as represented by a three-dimensional (3D) earth model, the method comprising:
defining a region of interest in the 3D earth model via at least one functional descriptor;
extracting data corresponding to the physical property of interest where the region of interest and the 3D earth model overlap; and
extracting hydrocarbons from the oil and/or gas field using the data extracted from the 3D earth model.
